(19) United States
(12) Patent Application Publication
(10) Pub. No.: US 2013/0063282 A1
(43) Pub. Date: Mar. 14, 2013

(54) ROADWAY DETECTION

(71) Applicants: David E. Baldwin, Madison, WI (US); Ahtasham Ashraf, Lewis Center, OH (US)

(72) Inventors: David E. Baldwin, Madison, WI (US); Ahtasham Ashraf, Lewis Center, OH (US)

(73) Assignee: CENTRAL SIGNAL, LLC, Madison, WI (US)

(21) Appl. No.: 13/699,168

(22) PCT Filed: May 30, 2011
(86) PCT No.: PCT/US11/38482

§ 371 Date: Nov. 20, 2012

Related U.S. Application Data
(60) Provisional application No. 61/350,000, filed on May 31, 2010.
(60) Provisional application No. 61/349,999, filed on May 31, 2010.
(60) Provisional application No. 61/358,374, filed on Jun. 24, 2010.

(51) Int. Cl. G08G 1/042

(52) U.S. Cl. 340/941

(57) ABSTRACT

Power efficient, modular sensor devices utilize magnetic sensor elements, wireless data communication and sensor device level processing to detect, evaluate and classify roadway vehicles. Sensor devices are configured in a network enabling data sharing between sensor devices. Earth generated magnetic fields are monitored within the range of each sensor device with reliability and stability over a wide range of environmental conditions and sensor device placements to detect field distortions specifically caused by a variety of roadway vehicles. Multiple sensor devices configured as a network, communicating with other sensor devices and one or more substations, collect, generate, share and evaluate data to determine multiple attributes of roadway vehicle events. Analog field distortion (waveform) measurements are converted to digital format and analysis on the detected waveform to classify the waveform event as a roadway vehicle of particular type and to determine a unique signature for the waveform event. Direction and speed of roadway vehicles and distinctions between roadway lane events can be realized, as well as detection of stationary roadway vehicles within sensor device range. Data is wirelessly transmitted between system elements to verify the integrity and health of all system elements on a continuing basis. One or more substation controllers and/or control stations and can configure, evaluate condition and status, process and relay unique signature data for a defined sensor device array, control operation of auxiliary devices and visual warning devices, and communicate with other substations and/or interface with a signal controller or central office.

### PRIORITY CLAIMS AND CROSS-REFERENCE TO RELATED APPLICATIONS

This patent application claims the benefit of and priority to the following prior filed and co-pending U.S. provisional patent applications, each of which is incorporated herein by reference in its entirety for all purposes:
U.S. Provisional Application No. 61/349,999 (Atty. Docket No. 0301-p06p) filed May 31, 2010, entitled “ROADWAY DETECTION” by Baldwin et al., including all Appendices;
U.S. Provisional Application No. 61/350,000 (Atty. Docket No. 0301-p07p) filed May 31, 2010, entitled “TRAIN DETECTION” by Baldwin et al., including all Appendices;
U.S. Provisional Application No. 61/358,374 (Atty. Docket No. 0301-p07p2) filed Jun. 24, 2010, entitled “TRAIN DETECTION” by Baldwin et al., including all Appendices.

This application is related to the following co-pending cases, each of which is incorporated herein by reference in its entirety for all purposes:
PCT International Application No. PCT/US2011/038481 (Attorney Docket No. 0301-p07 WO), entitled “TRAIN DETECTION” by Baldwin et al., filed on even date herewith, May 30, 2011;
U.S. Ser. No. 11/964,606 (Atty. Docket No. 0301-p03), filed Dec. 26, 2007, published Jul. 31, 2008 as United States Publication No. 2008/0183306 A1, entitled “VITAL SOLID STATE CONTROLLER” by Ashraf et al.;
U.S. Ser. No. 12/014,630 (Atty. Docket No. 0301-p04), filed Jan. 15, 2008, published Jul. 17, 2008 as United States Publication No. 2008/0169385 A1, entitled “VEHICLE DETECTION SYSTEM” by Ashraf et al.

### STATEMENT REGARDING FEDERALLY SPONSORED RESEARCH OR DEVELOPMENT

The invention was supported, in whole or in part, by Contract/Grant Numbers USDOT Phase 1 DRT57-08-C-10010 & USDOT Phase 2 DTRT57-09-C-10034 from the United States Department of Transportation. The United States Government may have certain rights in the invention in whole or in part.

One or more inventions in U.S. Provisional Application No. 61/350,000 (Atty. Docket No. 0301-p07p) filed May 31, 2010, entitled TRAIN DETECTION, and U.S. Provisional Application No. 61/358,374 (Atty. Docket No. 0301-p07p1) filed 31 May 2010, entitled TRAIN DETECTION, were supported, in whole or in part, by Contract/Grant Numbers USDA SBIR 1 2006-33610-16783 & USDA SBIR 2 2007-33610-18611 from the United States Department of Agriculture. The United States Government may have certain rights in an invention of that application in whole or in part.

### TECHNICAL FIELD

The present disclosure relates generally to systems, apparatus, methods and the like for detecting vehicles such as motor vehicles and the like, and processing data collected in connection with such detection. More specifically, the present disclosure relates generally to systems, apparatus, methods and the like for using collected vehicle detection data as part of larger systems—for example, a roadway incident detection and warning system; a traffic control system; a warning and/or advisory system for a roadway or the like; a construction zone traffic control and warning system; and other similar systems.

### BACKGROUND

Roadway incident detection systems have been an active research topic for some time. State highway departments and the like traditionally relied on police patrols to detect roadway incidents. Occasionally, roadside emergency call boxes were used to report incidents. Also, citizens band (CB) radio channels were established for reporting incidents. Loop detectors also have been used since the 1960s to monitor selected roadways (e.g., arterials, highways and the like). An incident detection process/algorithm using loop data may indicate a probable roadway/highway anomaly when an incident occurs. The equipment, installation and maintenance costs of inductive loop detectors prohibit their deployment in the density required for timely roadway incident detection. Driver-based (i.e., driver-reliant) incident detection systems, through CB radio, cell phones and other means of driver-initiated communication for example, when used, have been successful and timely in reporting incidents, but they are limited by the willingness of drivers to supply data, the accuracy of reported information, and the availability of appropriate communication resources. Some commercially available solutions have included video-based detection systems, which interface with closed circuit television (CCTV) video streams to detect changes in traffic flow. These systems are not very effective in detecting different levels of roadway congestion and are severely limited in some weather conditions (which is the time when many roadway incidents occur). In addition, the installation and data collection costs for widespread highway deployment are prohibitive. Necessary infrastructure to support these systems is not available for most rural roadways and installation costs generally prohibit use of these systems in “temporary” settings. Most prior sensing technologies available for roadway incident detection have included one or more of the following technologies: flux gate magnetometers magnetic sensors (for traffic flow parameter measurement), inductive loops/search coils magnetic detectors (for traffic-actuated signal control or signal counting), infrared, acoustic detection, ultrasonic detection, video detection, microwave radar detection, laser radar detection. Despite this assortment of technologies, alone or in combination, they have tended to fall short in one or more of the following: reliability, real time performance, accuracy, inclement weather performance, cost.

Systems, apparatus, methods, techniques, etc. that provide efficient, low-cost, reliable incident detection performance in a wide variety of settings and physical, weather and/or environmental conditions would represent a significant advancement in the art. It would be a further advancement to have such detection systems interface and interact with and/or be a subsystem within a variety of larger systems that allow for control, warning, informational and other interaction with vehicles and their operators.

### SUMMARY

Embodiments of roadway detection systems, apparatus, methods, techniques, etc. provide power efficient, modular sensor devices utilizing magnetic sensor elements, wireless data communication, and sensor device level processing to detect and classify roadway vehicles. Sensor devices are configured in a network enabling data sharing between sensor devices. Some apparatus and method embodiments provide for monitoring Earth-generated milliGauss fields (mGauss) within the range of each sensor element with reliability and stability over a wide range of environmental conditions and sensor device placements to detect mGauss field distortions (specifically caused by a variety of roadway vehicles) with multiple sensor devices configured as a network, communicating directly with other sensor devices to share and evaluate data to determine multiple attributes for roadway vehicle events within sensing range of the sensor device network. Other embodiments include methods of converting analog magnetic field distortion measurements to digital format and performing analysis on the detected waveform data to determine the classification of a given roadway vehicle and to determine the unique signature of the waveform event. Methods include processes to determine direction and speed of roadway vehicle movement and to distinguish between roadway lane events. Methods also include detecting standing or stationary roadway vehicles within sensor device range. Some method and apparatus embodiments transmit data wirelessly between system elements and verify the integrity and health of all system elements on a continuing time basis. Methods and systems according to some embodiments achieve real time sampling of traffic flow parameters by means of closely (or otherwise appropriately) spaced sensor devices configured as a sensing network to enable immediate recognition of significant traffic events and incidents, and immediate response thereto. Apparatus embodiments can include a substation controller and methods for configuring, evaluating condition and status, processing and relaying sensor device generated unique signature data for a defined sensor device array, controlling auxiliary devices and visual warning devices, operation and communication with adjacent substations and/or interfacing with a signal controller or central office.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a perspective view of one or more vehicle detection systems according to one or more embodiments of the present invention.

FIG. 2 is a block diagram of one or more sensor devices according to one or more embodiments of the present invention.

FIG. 3 illustrates alternate housings for sensor devices.

FIGS. 4A and 4B are illustrative sensor element analog waveform data plots.

FIG. 5 is a flow diagram of one or more methods according to one or more embodiments of the present invention.

FIG. 6 is a block diagram of one or more substation embodiments according to one or more embodiments of the present invention.

FIG. 7 is a block diagram of one or more control station embodiments according to one or more embodiments of the present invention.

FIG. 8 shows various sensor device placements usable in one or more embodiments of the present invention.

### DETAILED DESCRIPTION

The following detailed description will refer to one or more embodiments, but the present invention is not limited to such embodiments. Rather, the detailed description and any embodiment(s) presented are intended only to be illustrative. Those skilled in the art will readily appreciate that the detailed description given herein with respect to the Figures is provided for explanatory purposes as the invention extends beyond these limited embodiments.

Certain terms are used throughout the description and claims to refer to particular system components. As one skilled in the art will appreciate, various companies, individuals, etc. may refer to components by different names. This disclosure does not intend to distinguish between components that differ insubstantially. Also, phrases such as “coupled to” and “connected to” and the like are used herein to describe a connection between two devices, elements and/or components and are intended to mean physically and/or electrically either coupled directly together, or coupled indirectly together, for example via one or more intervening elements or components or via a wireless connection, where appropriate. The term “system” refers broadly to a collection of two or more components and may be used to refer to an overall system (e.g., a computer system, a sensor system, a network of sensors and/or computers, etc.), a subsystem provided as part of a larger system (e.g., a subsystem within an individual computer and/or detection system, etc.), and/or a process or method pertaining to operation of such a system or subsystem.

In this specification and the appended claims, the singular forms “a,” “an,” and “the” include plurals unless the context clearly dictates otherwise. Unless defined otherwise, technical and scientific terms used herein have the same meanings that are not inconsistent to one of ordinary skill in the art relevant to the subject matter disclosed and discussed herein. References in the specification to “embodiments,” “some embodiments,” “one embodiment,” “an embodiment,” etc. mean that a particular feature, structure or characteristic described in connection with such embodiment(s) is included in at least one embodiment of the present invention. Thus, the appearances of the noted phrases appearing in various places throughout the specification are not necessarily all referring to the same embodiment. In the following detailed description, references are made to the accompanying drawings that form a part thereof, and are shown by way of illustrating specific embodiments in which the invention may be practiced. These embodiments are described in sufficient detail to enable those skilled in the art to practice the invention, and it is to be understood that other embodiments may be utilized and that structural, logical, electrical and/or other changes can be made without departing from the spirit and scope of the present invention.

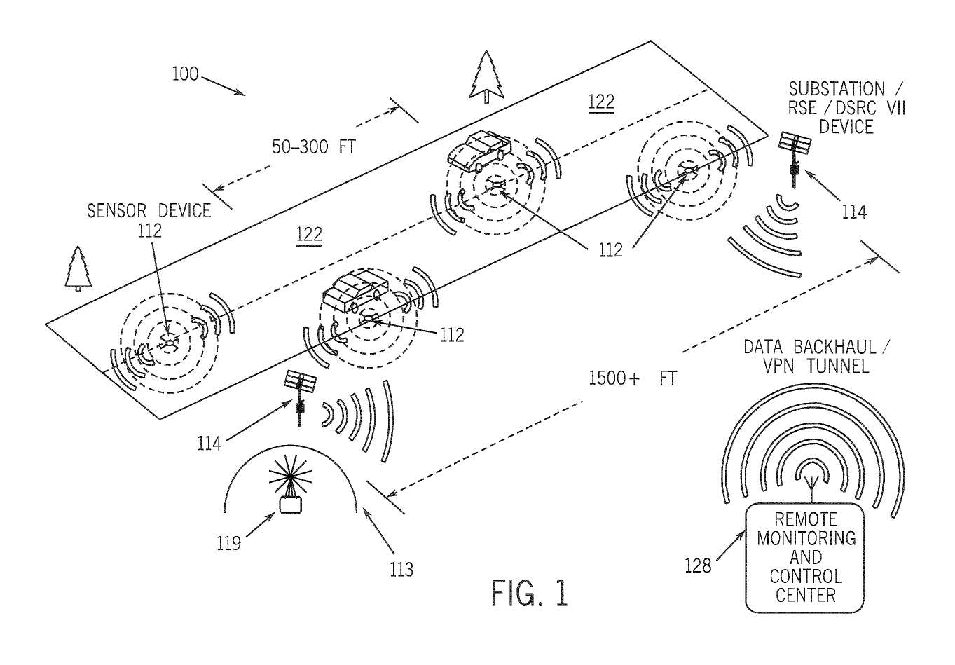

One or more embodiments of a roadway incident detection and warning system 100 are represented in FIG. 1. A roadway incident detection and warning system is used in much of this disclosure as an exemplary system by which one or more embodiments of the present invention can be illustrated, though the invention is not limited solely to such roadway incident detection and warning systems. As will be noted herein, other systems can utilize embodiments of the present invention (including method and/or apparatus and/or other embodiments), such as systems used for monitoring, controlling, warning, providing information, etc. in construction zones and the like. Therefore, the explanations of the various embodiments illustrated, disclosed and described herein are not limiting.

Temporary installations and/or implementations of one or more embodiments of the present invention can be used in such construction zones and/or in other areas where monitoring, incident detection, control, warning and/or informational functionalities can be useful on a temporary basis. Temporary construction zone sensor device arrays could include devices to detect roadway worker intrusion into the traffic zone and to provide real time visual warning to motorists of such events.

Other embodiments include wrong way traffic detection on freeway exit ramps and on any roadways equipped with this highway incident detection system. Configuration protocols for the highway incident detection system deployed on any roadway can include, at the user's option, wrong way vehicle detection. Sensor device programming includes the option of specifying direction of travel. When the sensor devices detect opposing (i.e., wrong way) traffic in a lane, the visual warning indicators can be activated to warn approaching motorists. In addition, the roadway or policing authority can be notified by substations receiving such data from roadway sensor devices. Substations so equipped can immediately deploy an airborne and/or other mobile sensor platform to provide additional data such as supplemental roadway data. Where highway incident detection system embodiments are deployed on limited access freeways, a sensor device array deployed on all access exit ramps can interface directly with special devices designed to stop the driver from entering the freeway the wrong way (e.g., flashing light arrays, sirens, barriers, etc.). If the driver continues onto the freeway into oncoming traffic the wrong way, the highway incident detection system can immediately be activated, thus warning drivers via flashing light indicators and notifying the policing and roadway authorities directly via the substation interfaces that a wrong way vehicle incident is occurring.

Several embodiments of the present invention can enhance traffic light signal operation at roadway intersections. Deployment of sensor device embodiments along arterials and intersecting streets provides data to traffic light signal controllers about traffic volume and speed on one or more of the roadway approaches to the controlled intersection. The traffic controller can use this real time data to adjust operation of the intersection's traffic signals to enable efficient traffic flows. This dynamic system can automatically adjust signal operation to actual traffic flow as it varies over time (e.g., through a day, weekend, weather condition, etc.). Consecutive controlled intersections can approximate synchronous/consecutive operation based on actual traffic flow at each intersection, automatically producing arterial synchronicity for heavy traffic. The improved efficiencies can yield substantial time and fuel savings. Facilitating a more natural traffic flow also can improve roadway safety, reducing accidents and injuries.

Other embodiments utilize placement of sensor devices on the roadway at regular intervals to provide internet data service to roadway users by routing internet data packets and other TCP/IP services. Such a system also can provide real time information to a vehicle concerning upcoming traffic and roadway conditions through wireless communication. This can include status of upcoming railroad crossings, bridge status, traffic congestion, traffic incidents, weather alerts, suggested route alternatives, etc. Some embodiments include airborne platforms equipped with one or more sensors that can include infrared detectors, radar devices, video sensors, or other appropriate sensors. The airborne platforms reside at intermediate sensor data stations in some cases, ready for immediate deployment to collect additional information when incidents are detected and to provide additional warning to motorists as required by protocols established by the roadway authority.

Installation of one or more roadway system embodiments can monitor an area of military importance including curfew zones, customs and border protection, etc. Another system embodiment can be used for providing a location radio beacon to vehicles and traffic along the roadway, thus eliminating the need for an individual Global Positioning System (GPS) unit in each vehicle and reducing the cost of location-based services.

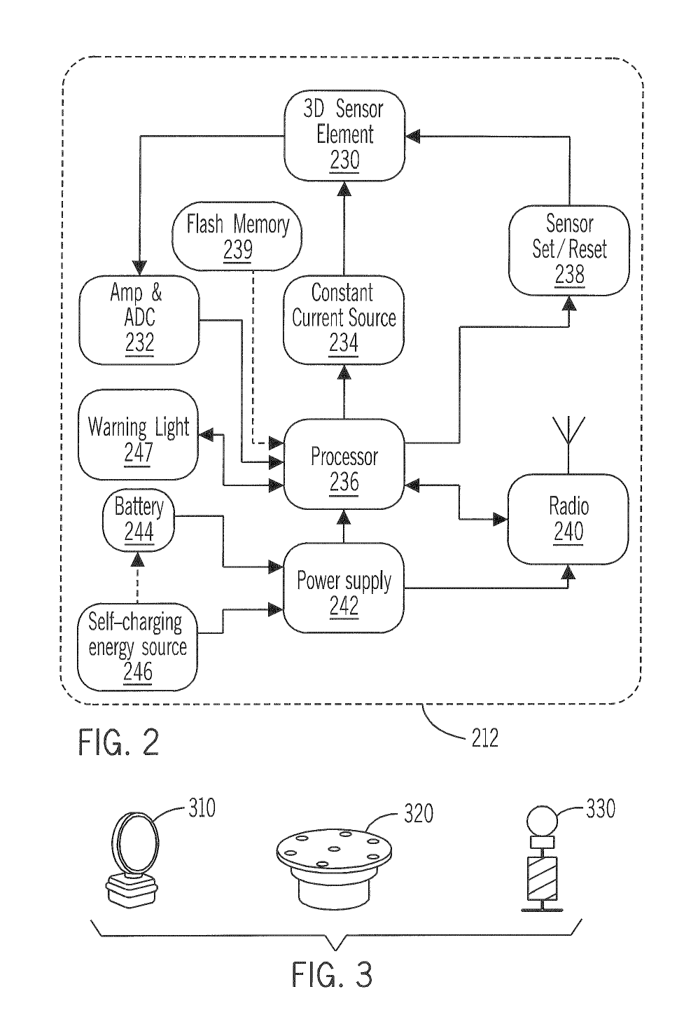

System 100 of FIG. 1 includes a plurality of sensor devices 112 (one or more embodiments of such sensor devices are shown in FIG. 2), one or more wireless substations 114 and one or more control stations 128 (which can be coupled to the substations 114 using wireless communications (e.g., using one or more wireless protocols such as IEEE 802.15.4 and frequencies such as 900 MHz, 2.4 GHz, 5.9 GHZ, etc.) and can provide remote monitoring and/or control of the substations 114 and/or sensor devices 112). Per FIG. 3, devices 112 can be housed in barricade flashers 310 and/or other portable, temporary housings (e.g., suitable for a construction zone or the like), in reflective markers 320 that are “snow-plow-proof” and useful for embedding devices 112 in the roadway itself, and/or in a mountable warning light 330 or other signal. Other housing alternatives will be apparent to those skilled in the art.

At a basic level, embodiments of system 100 collect data (“information” and “data” are used interchangeably herein unless specifically noted otherwise) about motor vehicles (and/or other traffic) on an exemplary roadway 122 or the like (roadways can be virtually any configuration of any number of lanes and traffic directions; various roadway configurations will require different sensor device placements). The collected data is then processed (in the devices 112, in the substations 114 and/or in the control stations 128, for example) to generate processed data and information that is sufficient to determine status, activity, conditions, etc. on the roadway 122, or may be used as one or more inputs to one or more processing methods that yield further information about activity, conditions, etc. on roadway 122. Examples of such methods and processing are provided below. Such exemplary systems provide timely status of traffic flow parameters and immediate detection of events of interest immediately. The prompt response of such systems can include information used to regulate and/or control activities on the roadway 122, to warn motor vehicle operators of hazardous and/or other conditions on the roadway 122, to provide information to motor vehicle operators about traffic conditions, to receive information from individual vehicles that is of interest to effective traffic flow management, etc. As will be appreciated by those skilled in the art, the use of collected (i.e., unprocessed) motor vehicle data, as well as processed data, can be used in a wide variety of applications to assist in making roadways and the like more safe, more efficient, etc.

In some embodiments a plurality of sensor devices 112 will collect data and supply the collected data to a single substation 114. Likewise, in some embodiments, a plurality of substations 114 can provide collected and/or processed data to a single control station 128, thus leveraging a large amount of collected data for use by a single control station 128 or the like. Similarly, sensor devices 112 can be grouped to provide overlapping coverage of a roadway 122 so that each sensor device 112 provides its collected data to multiple substations 114. Each substation 114 can also supply collected and/or processed data to multiple control stations 128 in an “overlapping” fashion. Similarly, multiple systems 100 can be configured to supply, collect, and/or process data from a single control station 128.

In system 100 of FIG. 1, each sensor device 112 can placed on, embedded in or otherwise fixed or mounted in appropriate proximity to roadway 122 (e.g., sensor devices can be placed in the middle of roadway lanes, at the edges of the roadway lanes, along lane dividers, etc.). One or more embodiments of a sensor device 112 from FIG. 1 are shown as sensor device 212 in the block diagram of FIG. 2 (unless indicated otherwise, the sensor devices 112 of FIG. 1 and sensor device embodiment 212 of FIG. 2 are interchangeable). Sensor device 212 of FIG. 2 includes one or more anisotropic magnetoresistive (AMR) sensor elements 230 (having one or more detection axes—e.g., one or more Wheatstone bridge configurations or the like) having an output coupled to the input of a combined amplifier and analog to digital waveform data converter (ADC) 232 which in turn is coupled to a processor 236 (which can be a microprocessor and/or other control device and in some embodiments can have any amplifier and ADC 232 integrated into the processor 236, though in some cases each separate sensor element 230 will have its own dedicated amplifier and ADC). Each sensor element 230 can be one of the following components made by Honeywell International Inc. of Morristown, N.J.—HMC1001, HMC1002, HMC1021, HMC1022—or can be one of the following components made by NVE Corporation of Eden Prairie, Minn.—AA002-02, AA003-02, AA004-00, AA004-02, AA005-02, AA006-00, AAH002-00, AAH004-00, AAL002-02. As noted above, amplifier/ADC component 232 can be part of a processor device functioning as processor 236, for example a Texas Instruments MSP430F427 ultra-low-power microcontroller or the like. The processor module 236 is the central control component of each sensor device unit 212, being powered by a power supply 242 in FIG. 2 that in turn can use a battery 244 and/or a self-charging and/or self-replenishing source 246, as described in more detail below. The power supply can include a Texas Instruments BQ24071 or BQ24070 single chip Li-Ion charge and system power path management IC. Processor 236 also regulates power to a constant current or other energy/power source 234 (e.g., a National Semiconductor LMC7101 CMOS operational amplifier or the like) used to operate the sensor elements 230. A sensor set/reset component 238 (e.g., a combination of an International Rectifier IRF7105 HEXFET power MOSFET and Maxim MAX662 low-profile flash memory supply) coupled to and controlled by the processor 236 can provide gain/offset compensation, feedback and/or compensation circuits 238 used to maintain optimum detection condition of sensor elements 230. A radio 240 (e.g., a unit including a Digi International XBP09-DMWIT (or XB24-DMDK) and a TI CC2530, providing system-on-chip functionality for 2.4 GHz IEEE 802.15.4/RF4CE/ZigBee operation) also can be housed in unit 112. The non-volatile memory can be implemented using an Atmel 16 megabit AT45DB161D flash memory or the like to store sensor device parameters, configuration data and/or bitstreams, data, etc. Sensor device 212 also can include a power supply/charge maintenance circuit 242, a battery (or ultra capacitor) 244, and a self-replenishing power source 246 (e.g., collecting energy from one or more solar, piezo, magnetic induction, etc. sources). In the roadway incident detection and warning system 100, where collected and/or processed data might be used to warn drivers of conditions, hazards, etc. on roadway 122, one or more traffic warning devices 247 (e.g., flashing lights or the like) also may be coupled to and/or be part of each sensor device 212, or may be separate from sensor devices 212, as will be appreciated by those skilled in the art.

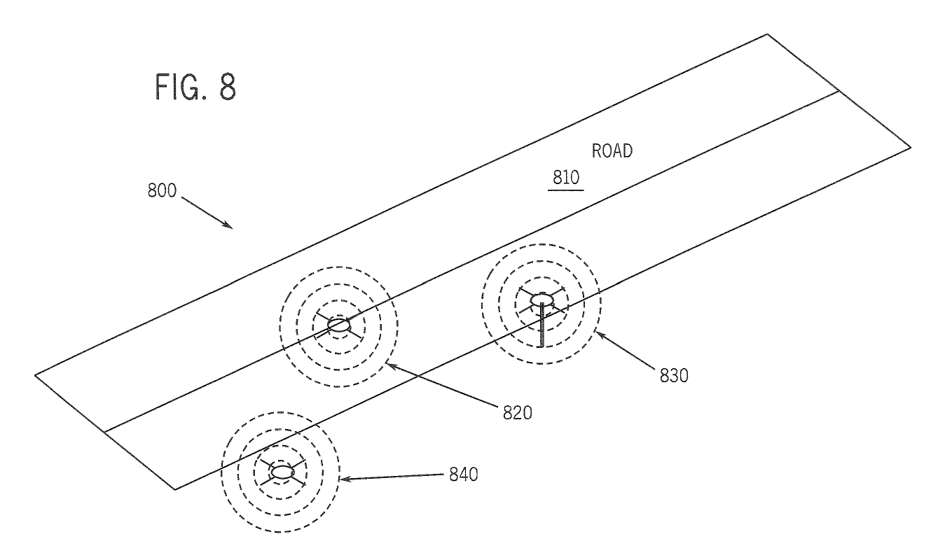

During operation, the sensor element 230 generates analog waveform data representing magnetic field changes due to a vehicle or other ferrous-containing object near the sensor device. Each sensor element 230 can be a single or multi-dimensional detector. Multi-dimensional waveform data provides improved sensitivity and precision as compared to one-dimensional sensor element data. FIG. 8 shows various sensor placement options, including installation between two lanes 820, in the midst of a traffic lane 830, and near the edge of the road 840. The advantages of placing sensor devices 112 at a particular location within a roadway depend upon the specific detection scheme desired and the physical, geographical and magnetic characteristics of the roadway. Placing sensor devices 112 at or near the lane divider (or dividing line) of adjacent traffic lanes provides unique opportunities to enhance the performance of the detection array, as described below.

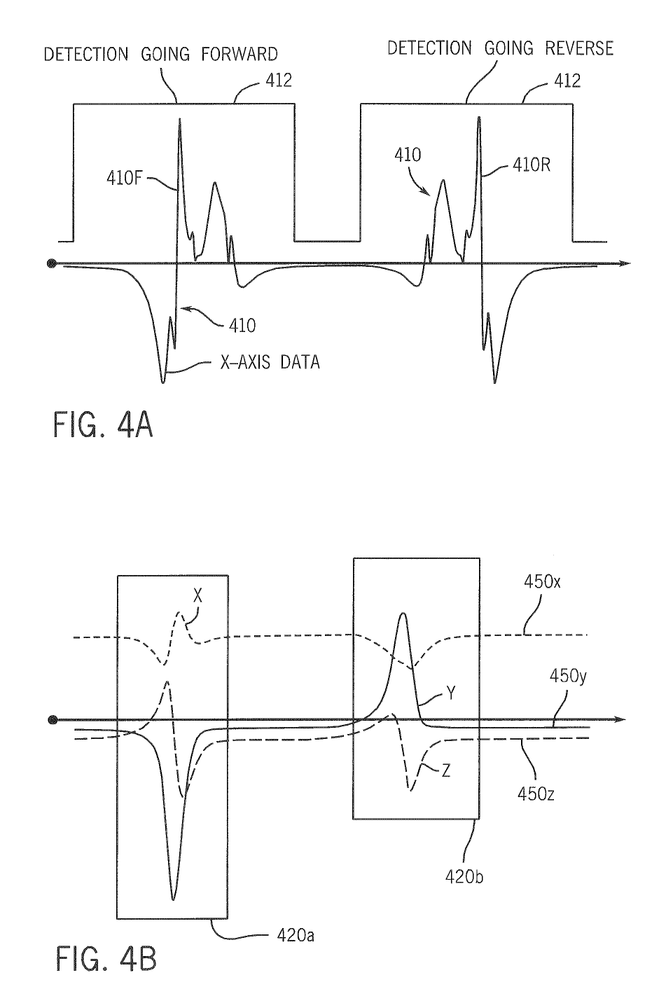

FIG. 4A is a plot of waveform data 410 generated by a multi-axle motor vehicle moving within range of a sensor device 112 placed at pavement level one foot from the edge of the roadway lane. The horizontal axis of the data plot represents elapsed time and vertical displacement represents magnetic flux density in milliGauss (mGauss). The waveform 410 was generated by an x-axis sensor element 230 (i.e., with its magnetic axis oriented parallel to direction of vehicle movement) responding to a vehicle moving in a first direction (e.g., “forward”) past the sensor device 112 within a data/event window 412, then stopping, then moving in the opposite direction (e.g. “reverse”) to move past sensor device 112 a second time within another data/event window 412. Analog waveform data 410 generated by the first movement 410F and by the second movement 410R is displayed. Waveform data 410R is essentially a mirror image of waveform data 410F. FIG. 4A demonstrates that waveform data generated by sensor elements 230 is sufficiently robust to support reverse movement detection 410R when compared to first movement waveform data 410F. Additional processing of the waveform data to compensate for waveform variations caused by vehicle behavior within the detection zone (i.e., velocity changes, lane changes, etc.) can classify vehicles according to their unique waveform characteristics.

FIG. 4B shows x-axis waveform data 450x, y-axis waveform data 450y and z-axis waveform data 450z generated by an AMR sensor device 112 placed between two, same-direction traffic lanes in a roadway. The first set of magnetic field perturbations 420a in the plot of FIG. 4B is generated by a motor vehicle moving in a first direction, while the second set of magnetic field perturbations 420b in the plot of FIG. 4B is generated by another motor vehicle moving in the same, first direction, but in the adjacent traffic lane. The x-axis of FIG. 4B's plot is parallel to the road, the y-axis is perpendicular to the road, and the z-axis is vertically upward.

When system 100 includes sensor devices placed between two roadway lanes, such sensor devices 112 can detect, distinguish between and classify vehicles moving within range of the sensor devices 112 in either or both directions in both lanes. As noted above, FIG. 4B shows waveform data generated by a sensor element 230 configured for three-dimensional detection of vehicles moving in the same direction in adjacent lanes (sensor device placed on or near lane divider). The multiple waveform plot of FIG. 4B shows time on the horizontal axis and magnetic field variation on the vertical axis. This time series demonstrates that for sensor devices 112 placed between lanes, waveform amplitude is correlated with specific lanes. A given vehicle moving within range of the sensor devices 112 in a first road lane will generate a waveform of negative (mGauss values decreasing) amplitude 420a. The same vehicle moving in the second lane that is adjacent and parallel to the first road lane will generate a waveform of positive (mGauss values increasing) amplitude 420b. Waveform peak polarity, especially noticeable in waveform data generated by the y-axis sensor element 230 (magnetic axis oriented perpendicular to the direction of vehicle travel), provides the means for a single sensor device to detect vehicles moving in either of two adjacent lanes and to determine in which lane the vehicle is moving. The waveform peak polarity is dependent upon the spatial relationship of the sensor device 112 to the roadway lanes and is independent of direction of vehicle movement. This enables sensor devices 112 placed at or near the lane divider of a two lane roadway to accurately detect the movement of vehicles in adjacent lanes and to identify the lane position of the vehicle whether vehicles in adjacent lanes are traveling in the same or in opposite direction.

Referring to the sensor device embodiment 212 of FIG. 2, analog waveform data of the type shown in FIGS. 4A and 4B is sent from each sensor element 230 to amplifier and analog to digital converter (ADC) 232. Processor 236 receives digitized data from ADC 232 and encodes the digitized data to generate encoded data in packets for transmission by radio 240. Sensor element 230 outputs a continuous signal to the amplifier module 232, which filters (e.g., removing noise, spikes, etc.) and amplifies the analog waveform for digitizing by the ADC. Processor 236 continuously drives current source 234 to each power sensor element 230. Constant current source 234 stabilizes the performance of each sensor element 230 exposed to large variations in temperature by providing constant current to each sensor element 230 as the value of resistive elements vary with temperature. Processor 236 also controls sensor set/reset module 238 which provides set and reset pulses that generate magnetic fields of sufficient strength near each magnetic sensor element to realign its magnetic domains. Domain realignment improves operational stability of sensor elements 230 by returning misaligned domains to proper alignment with the magnetic axis. Domain misalignment is a common effect in sensor elements 230 as a result of exposure to strong external magnetic fields.

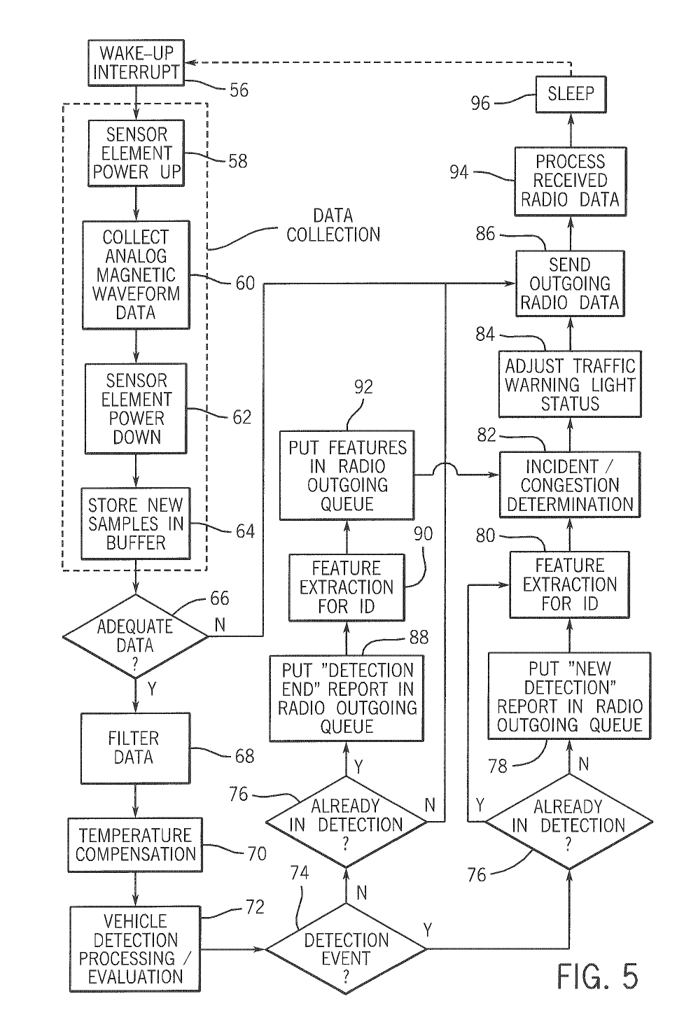

Referring to FIGS. 2 and 5, in some embodiments, sensor devices 112 operate in sleep/wake-up cycles and collect vehicle detections from an initial detection to a final detection of the same vehicle, thus generating a vehicle detection “report” or “event” for each motor vehicle that passes a single sensor device 112 and/or array of sensor devices 112. By generating and evaluating data reports on such detection “events,” a system 100 can derive information regarding individual motor vehicles, as well as information concerning the system (and roadway) as a whole. The system determines the “event” at individual sensor devices or within a sensor device array, which allows immediate identification and reporting of vehicle and/or traffic flow incidents or anomalies.

In the exemplary process illustrated in FIG. 5 (which can be performed for example by processor 236, by sensor device 112, and/or by other apparatus) a timer interrupt wakes up sensor device 112 at 56. One or more sensor elements 230 power up at 58 using constant current source 234 and then collect analog multidimensional waveform data at 60, representing the presence (or absence) of a vehicle within the sensing range of sensor device 112. Sensor element 230 then powers down at 62, at which time the collected waveform data are stored (e.g., in a memory buffer 239 in sensor device 112) at 64. A buffer check at 66 determines whether adequate data has been collected for processing to proceed (e.g., in cases when buffer 239 is sufficiently full) with data filtering at 68 (i.e., to remove noise). When buffer 239 does not hold sufficient data, processor 236 can direct sensor device 112 to 86 for further execution and/or to take other action. Sensor device 112 performs temperature compensation on collected analog waveform data at 70 using constant current source 234. This is done continuously in real time as data is being collected by processor 236. Collected analog waveform data filtered at 68 can be digitized and evaluated by one or more vehicle detection processes at 72.

In some embodiments, if X̅ₖ is the mean value of the waveform data taken over n samples Xₖ while σₖ is the standard deviation and Xₖ is the mean value over m number of samples such that m≧10 n then a detection is declared at 74 if:

|Xₖ− X̅ₖ|>τ₁ and σₖ>τ₂

where τ₁, τ₂ are the thresholds derived empirically from the actual waveform data.

Once a vehicle detection event is confirmed at 74, a check can be performed as to whether a vehicle detection is already in progress. If a prior vehicle detection was not in progress, then a new vehicle detection report is opened/generated and placed in the radio outgoing data queue at 78 to share, for example, with other sensor devices 112 and/or one or more substations 114. At 80 the digitized waveform data generated by an analog-to-digital conversion in the processor 236 at 72 is used to generate a unique vehicle identification signature and/or data related to such an identification signature, used for vehicle identification and classification.

If vehicle detection is not confirmed at 74, but a vehicle detection event was in progress, then an “end of vehicle detection” report is generated and placed in the outgoing radio data queue at 88. Any data remaining in the buffer is processed to extract a vehicle ID signature at step 90. The last vehicle ID signature extracted is placed in the outgoing radio data queue at 92 to be shared with other sensor devices 112 and/or one or more substations 114.

A variety of waveform data features such as number, magnitude, steepness, and sequence of waveform peaks can be used in detection, extraction and identification processes. In general, waveform peaks can be determined by evaluating maximum and minimum variation of magnetic flux density compared to a waveform base line value that corresponds to no vehicle within range of the sensor device. Other useful (but speed dependent) waveform data features include prominent frequency characteristics identifiable by calculating a Fourier transform of the time domain waveform data and selecting the dominant frequency features. One advantage of extracting peak flux density magnitude values is that peak values do not change as vehicle speed changes. As vehicle speed changes, waveform data peaks expand or contract along the time domain while preserving their relative positions (i.e., their sequence) and magnitudes, as well as important signature details. Moreover, peak data processing and mapping substantially reduces data storage, transmission, potential matching and signature matching complexity. Time-stamped peak sequences and peak amplitude/magnitude values are calculated and stored for matching purposes. Vehicle detection and ID signatures are passed on to a traffic incident/congestion detection process at 82. Congestion and incident detection processing evaluates traffic parameters such as speed, change of speed, rate of change of speed and vehicle spacing to determine traffic congestion and to detect traffic incidents and anomalies. When traffic congestion or a traffic incident is detected, drivers can be alerted immediately at step 84 though a variety of means including in-pavement or side of road traffic warning lights 247 or via system compatible on-board motor vehicle communications devices.

Sensor device radio 240 transmits traffic incident and congestion detection results to other sensor devices 112, system substations 114, and/or to the system control station 128 for immediate comparison, evaluation and appropriate action. In some embodiments radio transmission data is organized into fixed length data frames containing a sensor device ID, packet length, and cyclic redundancy check (CRC) checksum at 86. Transmitted data may include sensor device detection reports, warning light activation/deactivation notifications, status requests to and from the control station, setup/configuration commands from substations, etc. Data received by radio 240 is processed and executed at 94. The sensor device returns to sleep mode at 96 upon completion of the logic cycle; a new logic cycle begins at 56 when the wake-up timer expires. Some embodiments may use a 64 Hz wake/sleep cycle.

The configuration and operation of a roadway detection system according to one or more embodiments is determined by sensor device placement. Sensor devices 112 can be placed either on top of the roadway surface or below its surface. Placement of sensor devices within the roadway or adjacent to the roadway can be determined by functional parameters of the system (i.e., the information to be collected and how and to whom it is distributed). The spacing/distance between sensor devices 112 in some cases is limited by effective radio range. Sensor devices 112 in some embodiments are separated by 50 to 300 feet. In other embodiments placement separation may be one foot or several yards. Sensor device separation can be a function of the design speed of the roadway, unique roadway characteristics and functional parameters of the detection system (e.g., precision necessary to analysis of travel and position, and criteria for events of interest to the system—such as direction of traffic flow, stopped vehicle identification, reverse vehicle direction, traffic flow speed changes, etc.). Roadway detection embodiments can collect or generate information pertaining to a passing vehicle such as vehicle speed, direction, length, size, magnetic signature, etc. Because analog waveform data generated by a sensor element 230 is significantly different for passenger cars, SUVs, motorcycles, trucks, semi-trucks and trailers, construction vehicles, etc., embodiments like system 100 can detect, distinguish between and identify multiple vehicles and calculate the separation between passing vehicles.

Number, placement and configuration of sensor devices or the like determine the detection zone's spatial and/or data resolution for a given embodiment. The required resolution level may depend upon the accuracy needed to determine specific events within specified time frames. As will be appreciated by those skilled in the art, the specific parameters of a detection system layout can be based on system installation and operation requirements for a particular location. Achieving comparable data resolution for identical sensor device spacing on a 65 mph roadway compared to a 35 mph roadway is a function of sensor device clock speed. In some embodiments, the sensor device clock is an actual time clock (e.g., in “hh:mm:ss:msec & mm:dd:yyyy” format), maintained and updated through timer interrupt processes. Vehicle speed can be calculated by analyzing time-stamped vehicle detections at a plurality of sensor devices 112, which requires that individual sensor device clocks be synchronized. The synchronicity of sensor device clocks is essential to accurate speed measurement. Sensor device clock accuracy is a limiting factor of sensor spacing. A vehicle going 65 mph (95 ft/sec) travels the distance between two sensor devices 112 placed 50 feet apart in 524 milliseconds. A vehicle going 35 mph (51 ft/sec) travels the distance between two sensor devices 112 placed 50 feet apart in 974 milliseconds. Sensor device clock accuracy and synchronization of at least 100 milliseconds and 50 foot spacing provides speed estimates with 80% accuracy for 65 mph vehicles and 90% accuracy for 35 mph vehicles. Increasing sensor device clock accuracy and synchronization between sensors improves the time stamping accuracy of sensor-to-sensor speed calculations. Increasing the distance between sensor devices 112 increases the accuracy of time-stamped speed calculations proportionally. As those skilled in the art will appreciate, vehicle length, speed, size, etc. can be determined using data collected at multiple sensor device units 112 and/or considering multiple data collections at a single sensor device unit 112 (where a single sensor device unit 112 is able to collect multiple readings from a single motor vehicle as it passes the sensor device unit 112). In some embodiments, sensor devices are arrayed in a density per linear mile of the roadway to provide real time detection, monitoring, identification, control, warning, etc. of traffic and vehicles traveling on the roadway, which will depend on the normal vehicle speeds for such a roadway, as well as other possible criteria.

In some embodiments, identifying traffic congestion and incidents is accomplished through collaboration of two or more sensor devices 112. As those skilled in the art will appreciate, vehicle characteristics can include data about an individual vehicle (length, signature, average speed, etc.) as well as data collected and/or derived regarding vehicle groups on a roadway (traffic density, flow, speed changes, etc.). Data sharing between sensor devices 112 enables continuous assessment of traffic flow parameters such as traffic flow average velocity, velocity changes, rate of change, flow density, etc., as well as identifying individual vehicle velocity, velocity change, rate of change, spacing between vehicles, etc. Collaborative data collection and processing continuously applies incident detection and congestion criteria immediately to sensor device data as it is collected, enabling rapid and immediate evaluation of pertinent traffic flow parameters and appropriate system response (e.g., activating warning lights, transmitting alerts and notifications to appropriate authorities and systems).

Once an event or condition (e.g., congestion, disabled/stopped vehicle, accident, etc.) has been detected, a traffic warning and/or other action decision is made and implemented. A control station 128 can also be informed of the situation, allowing other action to be taken depending on the type and severity of the event (e.g., deploying an airborne or other mobile sensor or data collection platform, notifying law enforcement, EMS responders, a 911 operator, etc.). Warning devices can be activated in a predefined pattern (e.g., slow flashing, quickly flashing or steady red lights for an incident having a severe impact on traffic; yellow/orange lights for cautionary warnings of slower speeds, upcoming lane closures, etc.), where the warning pattern depends upon the type, urgency, severity, etc. of the incident. For example, traffic warning lights 247 can be activated in the vicinity of a detected event using radio communication between multiple sensor devices 112 and any warning devices controlled thereby. Once the traffic congestion or incident has cleared, the warning devices can be deactivated. An airborne or other mobile sensor or data collection platform 119 (a “mobile data collector”) can be deployed to send data wirelessly to the nearest control station for analysis and further distribution. In some embodiments the warning devices can also be remotely controlled by the control station 128.

Vehicle speed can be calculated on the basis of elapsed time between vehicle detections for two or more sensor devices 112 on a roadway. The sensor devices can be consecutive, neighboring, various pairs or other groupings selected to provide average vehicle speeds over longer stretches of the roadway (e.g., data from two sensor devices spaced one mile apart can yield the average vehicle speed over that mile). Time-stamped vehicle detections at two or more sensor devices 112 can be shared wirelessly between sensor devices in some embodiments and can be used to calculate a vehicle's average speed (α) between sensor devices 112 based on the sensor devices' known separation. The speed estimate α likewise can be shared directly between sensor devices 112 using a wireless network, or via substations 114 and/or control stations 128. An average traffic flow speed (β) also can be calculated periodically or continuously at each sensor device 112 and can be updated as appropriate. The value β can be calculated as a moving average of speed a over a fixed number of past time intervals. Monitoring changes in average traffic flow speed can be useful in determining a congestion condition and/or status. The rate of change of speed (γ) and consecutive vehicle spacing (δ) can be calculated and monitored. Vehicle spacing calculations may be based on average traffic flow speed and consecutive time-stamped vehicle detections at a particular sensor device 112.

Data processing in the form of one or more traffic incident and/or congestion detection processes can operate directly on parameters such as the above-defined α, β, γ, δ calculated at each sensor device 112 (and/or on other available data/information). One exemplary process for detecting traffic incidents and/or congestion problems comprises continuously monitoring average traffic flow speed β calculated at individual sensor devices 112. When a prescribed group and/or minimum number of sensor devices 112 determine that 13 has fallen below a predefined threshold, a congestion or incident condition is satisfied. Traffic warning devices 247 can be activated immediately with a predefined flashing pattern and notification sent to substation 114 and/or control station 128. When β values exceed predefined threshold criteria at a designated number of sensor devices 112, congestion/incident condition criteria are no longer satisfied. Traffic warning lights can be turned off as soon as the congestion clears or the incident is resolved.

Some embodiments of processing for detecting traffic congestion/incidents utilize the vehicle spacing parameter δ calculated at each sensor device 112. As with the use of β in the exemplary system above, one or more predefined threshold values for δ establish the criteria that must be satisfied to initiate or terminate a traffic congestion protocol. Another exemplary traffic incident detection process can be implemented using the rate of change of speed parameter γ (e.g., in monitoring sudden changes in traffic behavior). Each sensor device 112 calculates γ based on available collected data. If the value of γ exceeds predefined traffic incident criteria (e.g., shows a significant decrease in roadway vehicle speeds in a very short time period) a traffic incident protocol may be initiated immediately to display traffic warning lights, notify roadway authorities and alert law enforcement authorities. Such processing/detection is useful in traffic incident monitoring involving multiple vehicle accidents in which a number of vehicles are disabled. A sensor device 112 detecting a stopped vehicle within its sensing range can immediately initiate roadway congestion and incident protocols. As will be appreciated by those skilled in the art, two or more protocols may be active at the same time and may be combined with other processes to develop useful rapid response traffic monitoring systems and the like.

Additionally, in some embodiments, sensor devices 112 are configured to reduce erroneous vehicle detections (sometimes referred to as “falsing”) due to environmental conditions, component failure or malfunction, supply voltage variations, etc. Sensor devices 112 can dynamically update or correct the “bias” value of each sensor element 230 by determining proper sensor element bias and correcting a current sensor element bias value when that current sensor element bias value deviates sufficiently from the optimal bias setting. Such dynamic bias updating maintains more accurate detection operation for each sensor element 230, thus enhancing the accuracy of collected data and any processes dependent thereon, and reducing the likelihood of false positive or false negative detections.

Bias value monitoring is important in some embodiments to compensate for sensor element bias drift due to environmental changes (e.g., temperature variation) that can induce falsing. In FIG. 2, sensor device 212 includes one or more sensor elements 230, amplifier/ADC 232, set/reset circuit 238, processor 236, and constant current source 234. Processor 236 controls the set/reset circuits 238 required to maintain optimal detection performance for each sensor element 230. Set/reset circuit 238 typically includes a magnetic flux generating coil that sets and resets the magnetic domains in a sensor element 230, removing bias caused by undesirable magnetic phenomenon, temperature effects, etc. Processor 236 applies short pulses to circuit 238, and the resultant samples generated by sensor element 230 are used to calculate an appropriate compensation bias, enabling sensor element 230 to operate in its optimum range, even in environments having varying temperature, humidity, flux density, etc.

Some embodiments include installation of sensor devices 112, substations 114 and control stations 128 at remote locations on, in or near a roadway. In such embodiments, an “independent” power supply is helpful (that is, a power supply that does not require connection to an outside power source and that does not require expensive or frequent replacement of the power supply), for example a battery, wind-driven generator, solar power system, piezo energy harvester or other self-sustaining (i.e., self-recharging) power technique/source. Each sensor device 112 can operate on a rechargeable battery and/or ultracapacitor, connected through a charger (e.g., a voltage regulator) to a wind-driven generator, small solar panel, piezo transducer or the like. Similarly, the substations 114 can be powered by a battery that is connected to a similar self-sustaining, self-charging power source such as a wind-driven generator, a solar panel or other energy-harvesting device.

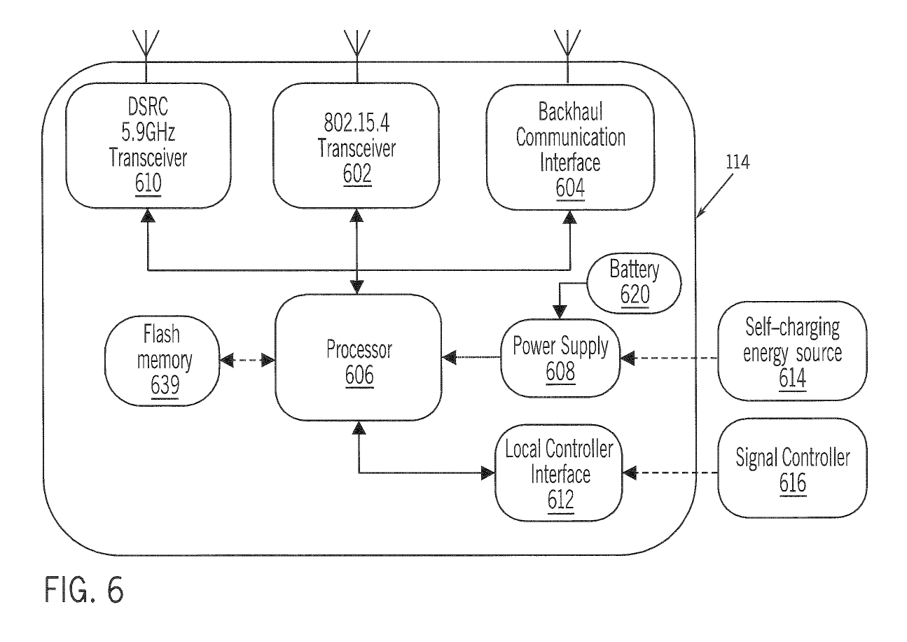

Referring to FIG. 6, some embodiments of substation 114 include a processor 606 (e.g., a Pentium 1 GHz processor with 512 MB of RAM and 8 GB flash capacity) powered by a switching power supply 608 normally used in computing devices such as laptops, a battery and/or ultracapacitor 620 and a self-recharging, self-sustaining power source 614 (e.g., solar, piezo transducer, wind-driven generator, etc.). Each substation 114 in these embodiments also includes a local signal controller interface 612 coupled to a signal controller 616. This interface can connect the processor 606 to the external signal controller 616 using RS232/RS485 serial protocols. External communication can be implemented using a variety of techniques and/or apparatus, such as an IEEE 802.15.4 wireless transceiver 602 (e.g., a combination Digi International XBP09-DMxxx and Texas Instruments CC2530), a backhaul data communication interface 604 (e.g., a WiMax, 3G Wireless, etc.), and a 5.9 GHz wireless transceiver 610 (e.g., a dedicated short range communication (DSRC) device like a Kapsch eWave Module). The substation 114 may also include a global positioning system (GPS) chip/module. The substations 114 can be mounted on roadside posts or other appropriate locations, typically in proximity to the roadway, and may include one or more energy harvesting solutions (e.g., self-sustaining and/or self-recharging energy devices) mentioned herein. Each substation 114 is vehicle infrastructure integration compliant and the 5.9 GHz DSRC interface 610 enables a substation 114 to communicate with roadway vehicles. In other embodiments, the substation can be distributed apparatus that performs the functions described herein for the substation 114. For example, in some cases sensor devices might serve as cooperative parts of a substation (e.g., performing processing, communicating with a control center, verifying the operational status of other sensor devices in a system) in a distributed manner. Also, a “master” sensor device might be designated, equipped and/or programmed to perform in a dual role as both a sensor device and the substation. For purposes of illustration, a substation apparatus is depicted and described in connection with a number of roadway detection embodiments herein, but is not limiting. In some embodiments, each substation 114 can be equipped with an airborne sensor platform 119 equipped with video, infrared, radar or other sensors that enable an operator at a remote location to scan roadway areas near the given substation 114. For example, a small helicopter similar to the HexaKopter/MikroKopter made by Holger Buss and Mikrocontroller.com of Germany, can be housed in a small, domed enclosure 113 that protects the helicopter from weather and provides recharging for the unit's batteries, while still allowing easy access to the roadway areas for video surveillance and/or verification of congestion, incident, etc. notifications.

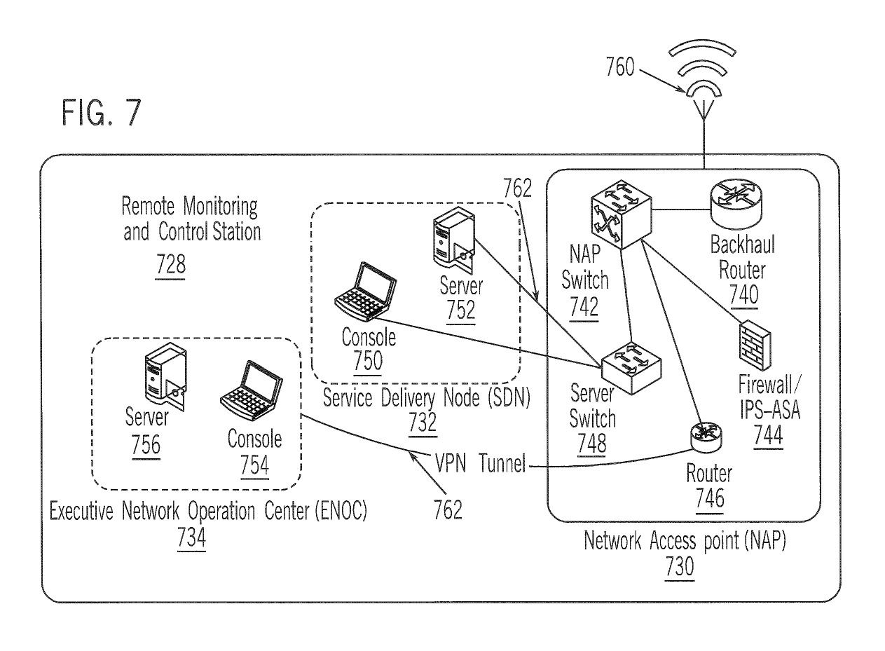

Substations 114 can be placed 1,500 to 5,000 feet apart in some embodiments and receive data from a given range, sub-set or other group of sensor devices 112 and warning devices 247 through the IEEE 802.15.4 interface 602. Data and service requests destined for sensor device 112 from a control station 128 can be routed through a substation 114 using the same wireless interface. DSRC interface 610 enables data exchange with roadway vehicles. Roadway vehicles (e.g., those shown in FIG. 1) can use onboard equipment (OBE) with a DSRC transceiver and/or other interfaces to vehicle electronic/mechanical components, which may or may not operate on a Controller Area Network CAN Bus, normally used for communication between electronic components in the automotive industry. The backhaul data communication interface 604 provides long range communication to substation 114. The range of this interface is not limited; it can operate as a virtual private network (VPN) tunnel (e.g., tunnel 762 of FIG. 7) for network purposes. Local controller interface 612 communicates with a signal controller 616 (e.g., EPAC300, NEMA TS 1-1989 and NEMA TS 2-2003).

Referring to FIG. 7, embodiments of a control station 728 include a network access point 730, a service delivery node 732, and an executive network operation center 734. The network access point 730 includes a backhaul data router 740 that is connected to a wireless communication interface (e.g., 3G, WiMax, satellite communication, etc.) and antenna 760. Router 740 channels all communications with substations and sensor devices, and is coupled to a network access point switch 742 which, in turn, is coupled to a firewall 744, a server switch 748 and a router 746. Firewall 744 can be an intrusion prevention system capable device (e.g., an ASA 5505). Server switch 748 provides an interface to the service delivery node 732 and its main components, server 752 and console 750.

In service delivery node 732, console 750 can be used for test purposes, while server 752 delivers primary remote operation functionalities for control station 728 (e.g., sensor device configuration, network configuration, traffic status, warning light control, etc.). A software user interface at server 752 can support these tasks. Some of the service protocols usable at the service delivery node 732 include advisory message distribution service (enabling network users to send road sign, advisory, sensor device data management, etc. messages); probe data service (enabling distribution of sensor device data from a substation to network user subscribers); information lookup service (enabling network users to look up substation IP, location, status, etc. information); vehicular host identity protocol (enabling selected sensor devices and/or substations to maintain a data session as vehicles pass from one sensor device and/or substation detection zone to another); tolling to enable a substation to simulate a tolling transaction; and positioning service (for determining vehicle locations).

Executive network operation center 734 manages and monitors the overall system and includes server 756 and test console 754 to carry out these functions (e.g., based on network management service and identity and access management service protocols). The network management service collects, aggregates, and forwards network management data to the executive network operation center 734. Moreover, the network management service also facilitates local on-site management and troubleshooting at the service delivery node 732 as well as remote management and troubleshooting from the executive network operation center 734. Identity and access management service provides security functions on the service delivery node 732, substations, the executive network operation center 734, and external users (e.g., administrative users and network users). These security management functions can be provided using a certificate-based access control. Using such components, embodiments of control station 728 provide configuration options, firmware updates, device reprogramming, and testing options to users and also provide remote status checking, alarm notification, limited configuration and data transfer.

Embodiments of AMR sensor-based vehicle detection and roadway incident detection systems of the present invention have a number of advantages over loop detector-based systems. Loop detectors suppress fine details of vehicle signatures because they can only collect combined signatures from the three spatial axes. Loop detectors also require the use of oscillator circuits (which often require switching between oscillator frequencies to adapt to conditions for vehicle, motorcycle and bicycle detection). Loop detector power requirements necessitate access to a commercial power supply, enormous solar panel, wind mill, etc. and the wiring connections and loop sizes require extensive cabling and conduit systems within the roadway zone making them disproportionately expensive for many applications. AMR sensor elements are solid state devices that can be managed for power efficient operation and placed in small housings that can be rapidly deployed in wireless communication matrices, eliminating the need for access to commercial power and the installation of connecting cables and conduits, significantly reducing installation and maintenance issues and costs. Loop detectors provide single axis “blurred” data rather than the more precise and discriminating multiple axis waveform data generated by AMR sensor elements, which also can be generated for vehicles that are not moving. Finally, AMR sensor elements permit accurate adjustment to accommodate temperature variations and saturation issues.

Systems according to one or more embodiments of the present invention also enjoy advantages over traffic monitoring systems based on cell phone call collection, tracking, etc. Some embodiments of the present invention immediately provide more accurate, real-time information about traffic conditions on a roadway without the significant delay and reliability issues that are present in cell phone tracking solutions. Moreover, roadway incident detection and warning systems according to some embodiments of the present invention provide immediate, real time, direct traffic warnings that can be controlled automatically by the system and/or manually by the roadway authority, as well as providing direct and immediate interface to roadway traffic lights and other options for future roadway-vehicle interaction based applications.

Roadway traffic data and vehicle information from sensor devices 112 are communicated via wireless channel to substation(s) 114 and control station(s) 128. Wireless connections can be chosen from a variety of wireless protocols and frequencies (e.g., 900 MHz or 2.4 GHz). Roadway detection systems, methods, etc. herein are not limited to a specific number of sensor devices 112. Roadway detection systems, methods, etc. can encompass continuous roadway systems such as interstate highway systems for their entire length or can be placed to monitor discrete locations within the roadway system. Such systems, methods, etc. may be deployed to monitor very specific traffic flow parameters and configured to provide very specific information; or, they may be configured to collect data necessary to many different tasks and services. The various system components (i.e. sensor devices 112, substation(s) 114 and control unit(s) 128) collaborate with each other as described herein to provide immediate and accurate traffic incident detection, congestion detection, one or more motor vehicle warning and/or informational signs and/or displays, etc.

Many features and advantages of the invention are apparent from the written description, and thus, the appended claims are intended to cover all such features and advantages. Further, numerous modifications and changes will readily occur to those skilled in the art, so the present invention is not limited to the exact operation and construction illustrated and described. Therefore, described embodiments are illustrative and not restrictive, and the invention should not be limited to the details given herein but should be defined by the following claims and their full scope of equivalents, whether foreseeable or unforeseeable now or in the future.

1-42. (canceled)

43. A roadway detection system comprising:
a wireless substation comprising:
a substation power supply;
a communication receiver; and
a substation processor; and
a plurality of sensor devices fixed within a sensor device sensing range of a roadway, wherein at least a portion of the plurality of sensor devices are embedded in the roadway approximately between roadway traffic lanes, wherein each sensor device comprises:
a sensor device power supply;
one or more anisotropic magnetoresistive (AMR) magnetic sensor elements powered by the sensor device power supply and configured to generate analog waveform data representative of vehicles passing within the sensor device sensing range;
a sensor device processor configured to digitize analog waveform data generated by each AMR sensor element and to generate time-stamped digital vehicle identification data, wherein vehicle identification data comprises at least one of the following:
the sequence and magnitude of peaks derived from analog waveform data collected by the sensor device's one or more AMR sensor elements;
a unique vehicle identification signature;
a radio configured to transmit digital vehicle identification data from the sensor device to the wireless substation communication receiver; and
a sensor element set/reset unit to adjust a detection condition of each sensor element, including providing at least one of the following:
gain/offset compensation, feedback; compensation circuits;
wherein the substation processor is configured to process digital vehicle identification data transmitted by each sensor device radio to generate roadway condition data in real time, the roadway condition data comprising at least one of the following:
vehicle information comprising one or more of the following: vehicle speed; vehicle motion; vehicle direction; vehicle length; vehicle size; vehicle magnetic signature; vehicle speed; vehicle change of speed; vehicle rate of change of speed; vehicle spacing;
roadway information comprising one or more of the following: traffic flow; traffic density; traffic conditions; traffic incidents; individual vehicle information.

44. The system of claim 43 wherein each AMR sensor element is configured to generate at least one of the following: two-dimensional analog waveform data; three-dimensional analog waveform data.

45. The system of claim 44 further comprising a control station in wireless communication with the wireless substation, wherein the control station is configured to monitor and control a plurality of roadway detection systems and wireless substations.

46. The system of claim 45 further comprising a mobile data collector configured for airborne travel above the roadway and configured to collect roadway data, wherein the mobile data collector is controlled at least in part by the wireless substation.

47. The system of claim 46 wherein the plurality of sensor devices are arrayed in a density per linear mile of the roadway to provide real time monitoring of traffic and vehicles traveling on the roadway.

48. The system of claim 47 wherein the digital vehicle identification data and/or roadway condition data are used at least in part for at least one of the following: detecting in real time traffic congestion, detecting in real time disabled/stopped vehicles, detecting in real time accidents, controlling traffic light signals, controlling in real time roadway warning signals.

49. A roadway detection system comprising:
a wireless substation;
a plurality of sensor devices fixed within a sensor device sensing range of a roadway, wherein each sensor device comprises:
one or more anisotropic magnetoresistive (AMR) magnetic sensor elements configured to generate analog waveform data representative of vehicles passing within the sensor device sensing range;
processing apparatus comprising:
an analog-to-digital converter (ADC) configured to generate digital waveform data by converting analog waveform data generated by each sensor element; and
a processing unit configured to process generated digital waveform data from the ADC to vehicle identification data; and
a radio configured to transmit digital vehicle identification data from the sensor device to the wireless substation;
wherein the digital vehicle identification data is used to determine at least one of the following: vehicle activity on the roadway; traffic conditions on the roadway.

50. The system of claim 49 wherein each sensor device further comprises a power supply and a sensor element set/reset unit to adjust detection condition of each sensor element, including providing at least one of the following: gain/offset compensation, feedback; compensation circuits.

51. The system of claim 50 wherein the wireless substation comprises:
a communication receiver for receiving digital vehicle identification data transmitted by the sensor devices;
a substation processor configured to process the received digital vehicle identification data to generate information concerning at least one of the following: traffic flow, traffic conditions, traffic incidents, individual vehicle information; and
a substation power supply.

52. The system of claim 51 wherein digital vehicle identification data comprises one or more of the following: sequence and magnitude information regarding peaks in analog waveform data generated by each sensor element; a unique vehicle identification signature, wherein the unique vehicle identification signature is sufficiently distinct to permit re-identification of a roadway vehicle by multiple sensor devices and/or multiple substations.

53. The system of claim 52 further comprising a control station in wireless communication with the wireless substation, wherein the control station is configured to monitor and control a plurality of roadway detection systems and wireless substations.

54. The system of claim 53 wherein the digital vehicle identification data is used at least in part for at least one of the following: detecting traffic congestion, detecting disabled/stopped vehicles, detecting accidents, controlling traffic light signals, controlling roadway warning signals.

55. The system of claim 54 wherein at least a subset of the plurality of sensor devices are embedded in the roadway approximately between two roadway traffic lanes to allow detection of vehicles in one or both lanes in either direction.

56. The system of claim 55 further comprising a mobile data collector configured for airborne travel above the roadway and configured to collect roadway data, wherein the mobile data collector is controlled at least in part by the wireless substation.

57. A roadway incident detection and warning system characterized by:
a substation coupled to wirelessly to the control station and positioned adjacent to a roadway; and
a plurality of spaced apart sensor units embedded in the roadway, wherein each sensor unit comprises:
a three-dimensional anisotropic magnetoresistive (AMR) sensor element configured to generate three-dimensional analog waveform data when a motor vehicle passes within a minimum sensing distance from the sensor element;
a waveform data converter coupled to the AMR sensor element configured to filter and convert the generated waveform data from the sensor element to generate time-stamped, digital waveform data;
a processor coupled to the waveform data converter and configured to process the digital waveform data to generate at least one of the following: vehicle information, traffic information;
a radio coupled to the processor and configured to transmit and receive at least one of the following: data and information concerning digital waveform data generated by the sensor unit, instructions from the substation, updates from the substation, data and information concerning digital waveform data generated by other sensor units;
wherein each sensor unit is configured to process collected analog waveform data to generate information concerning at least one of the following: vehicle average speed, average traffic flow speed, rate of change of speed, consecutive vehicle spacing;
further wherein one or more warning devices are activated and deactivated based on the generated information by at least one of the following: one of the sensor units, the substation, the control station.

58. The roadway incident detection and warning system of claim 57 further comprising a control station wirelessly coupled to the substation, wherein the radio is further configured to transmit and receive at least one of the following: instructions from the control station, updates from the control station.

59. The roadway incident detection and warning system of claim 58 wherein the control station comprises:
an executive network operation center comprising a first server and a first console;
a service delivery node comprising a second server and a second console; and
a network access point (NAP) comprising:
a backhaul router coupled to an antenna configured to transmit to and receive from any substations in the roadway incident detection and warning system;
a NAP switch coupled to the backhaul router and to a server switch, wherein the server switch is coupled to the second server and the second console; and
a NAP router coupled to the NAP switch and to the first console.

60. The roadway incident detection and warning system of claim 59 wherein vehicle information and traffic information comprise time-stamping of vehicle detection information.

61. The roadway incident detection and warning system of claim 60 wherein each substation comprises:
communication apparatus configured to transmit and receive data comprising one of the following: airborne sensor platform sensor transmissions generated by video, infrared, radar sensors, warning light activation/deactivation notifications, status requests to and from the control station, setup/configuration commands from substation etc comprising IEEE 802.15.4 wireless transceiver, 5.9 GHz Dedicated Short Range Communication (DSRC) radio interface and long range communication interfaces such as WiMax, 3G etc; and
a processor coupled to the communication apparatus and configured to do at least one of the following: control operation of the communication apparatus;
control warning signal activation and deactivation; receive and transmit data through the communication apparatus; decode and process messages destined for the substation; provide substation testing and configuration features.

62. The roadway incident detection and warning system of claim 61 wherein each sensor device radio is configured to do at least one of the following: act as a router/packet forwarder for other sensor device radios to implement a network that can deliver information to any other sensor device in the system by sensor device radio transmission; exchange sensor device information with the closest substation radio.
